(19) United States
(12) Patent Application Publication
(10) Pub. No.: US 2020/0364430 A1
(43) Pub. Date: Nov. 19, 2020

(54) METHOD AND FINGERPRINT SENSING SYSTEM FOR DETERMINING THAT A FINGER COVERS A SENSOR AREA OF A FINGERPRINT SENSOR

(71) Applicant: FINGERPRINT CARDS AB, Göteborg (SE)

(72) Inventor: Troels BJERRE, VALBY (DK)

(73) Assignee: FINGERPRINT CARDS AB, Göteborg (SE)

(21) Appl. No.: 16/640,415

(22) PCT Filed: Sep. 3, 2018
(86) PCT No.: PCT/SE2018/050885

§ 371 Date: Feb. 20, 2020

(30) Foreign Application Priority Data
Sep. 7, 2017 (SE) 1751086-8

(51) Int. Cl. G06K 9/00; G06K 9/03

(52) U.S. Cl. CPC G06K 9/0002; G06K 9/036; G06K 9/00053; G06K 9/00026

(57) ABSTRACT

The present disclosure relates to a method of determining that a finger covers a sensor area of a fingerprint sensor. The method comprises, on a surface of the fingerprint sensor, receiving a finger having a fingerprint topography. The method also comprises, by means of the fingerprint sensor, acquiring an image of the fingerprint of the received finger. The method also comprises dividing an image area of the acquired image, corresponding to the sensor area of the fingerprint sensor, into a plurality of image regions (r), said regions partly overlapping each other and covering the whole image area. The method also comprises, based on image analysis of each of the plurality of image regions, determining that the finger covers the whole sensor area.

### TECHNICAL FIELD

The present disclosure relates to a method and to a fingerprint sensing system for determining that a finger covers sensor area of a fingerprint sensor.

### BACKGROUND

Various types of biometric systems are used more and more in order to provide for increased security and/or enhanced user convenience.

In particular, fingerprint sensing systems have been adopted in, for example, consumer electronic devices, thanks to their small form factor, high performance and user acceptance.

Fingerprint sensors can sometimes get activated prematurely, before the finger has made proper contact with the fingerprint sensor, or unintentionally, by a finger or other body part making contact with the fingerprint sensor by mistake, unnecessarily using up power and processing resources. It is preferable that a fingerprint sensor is only activated when a finger makes proper contact with it.

US 2015/0070137 discloses a method using electric field sensors for determining whether a sufficient part of the fingerprint sensor is covered by a finger, and whether the finger is in stable contact. It is determined whether a threshold number of subarrays from at least three of five regions of the fingerprint sensor have acquired finger stability data indicative of a finger. Then it is determined whether the finger is stable based upon whether the threshold number of sub-arrays indicates stability over successive data acquisitions.

### SUMMARY

It is an objective of the present invention to provide an improved way of determining whether a finger covers the whole of a sensor area of a fingerprint sensor.

It has now been realised that it may be desirable to further ensure that the whole of a sensor area of the fingerprint sensor detection surface is properly covered by a finger before performing an action, e.g. for navigation actions, where not only certain points of the fingerprint are studied. Navigation actions may e.g. include pressure detection indicative of a push/click on a button or link or the like, and movement detection indicative of steering a pointer or the like, e.g. of a graphical user interface, GUI. Also for fingerprint authentication it may be advantageous that the whole sensor area is covered by the finger before performing an authentication action.

According to an aspect of the present invention, there is provided a method of determining that a finger covers a sensor area of a fingerprint sensor. The method comprises, on a surface of the fingerprint sensor, receiving a finger having a fingerprint topography. The method also comprises, by means of the fingerprint sensor, acquiring an image of the fingerprint of the received finger. The method also comprises dividing an image area of the acquired image, corresponding to the sensor area of the fingerprint sensor, into a plurality of image regions, said regions partly overlapping each other and covering the whole image area. The method also comprises, based on image analysis of each of the plurality of image regions, determining that the finger covers the whole sensor area.

According to another aspect of the present invention, there is provided a computer program product comprising computer-executable components for causing a fingerprint sensing system to perform an embodiment of the method of the present disclosure when the computer-executable components are run on processing circuitry comprised in the fingerprint sensing system.

According to another aspect of the present invention, there is provided a fingerprint sensing system comprising a fingerprint sensor, processing circuitry, and data storage storing instructions executable by said processing circuitry whereby said fingerprint sensing system is operative to, on a surface of the fingerprint sensor, receive a finger having a fingerprint topography. The fingerprint sensing system is also operative to, by means of the fingerprint sensor, acquire an image of the fingerprint of the received finger. The fingerprint sensing system is also operative to divide an image area of the acquired image, corresponding to a sensor area of the fingerprint sensor, into a plurality of image regions, said regions partly overlapping each other and covering the whole image area. The fingerprint sensing system is also operative to, based on image analysis of each of the plurality of image regions, determine that the finger covers the whole sensor area.

According to another aspect of the present invention, there is provided an electronic device comprising an embodiment of the fingerprint sensing system of the present disclosure, and a device control unit configured to interact with the fingerprint sensing system.

If it is only checked that a few separate parts of the sensor area are covered by a finger, nothing is known about whether the finger is covering also the sensor area between said parts. By dividing the image area, corresponding to the sensor area, into image regions which together cover the whole image area, the risk of not detecting non-covered parts of the sensor area is reduced. However, a non-covered part of the sensor area which extends over two adjacent, but not overlapping, image regions of the corresponding image area may still not trigger detection of the non-covered part since the non-covered part is divided between two or more regions, each only being affected to a relatively small degree. The solution of the present invention is to use overlapping regions, whereby there is increased probability that at least one of the regions is affected to such a degree that detection of the non-covered part is made by image analysis.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 schematically illustrates an electronic device including a fingerprint sensing device, in accordance with an embodiment of the present invention.

FIG. 2 is a schematic block diagram of the electronic device in FIG. 1.

FIG. 3 schematically illustrates a time-sequence of images, in accordance with an embodiment of the present invention.

FIG. 4 schematically illustrates an image area corresponding to a sensor area of fingerprint sensor, in accordance with an embodiment of the present invention.

FIG. 5a illustrates an image area divided into overlapping image regions, in accordance with an embodiment of the present invention.

FIG. 5b illustrates a representation of an uncovered sensor area part in overlapping image regions.

FIG. 6 shows a time-sequence of grey-scale images, in accordance with an embodiment of the present invention.

FIG. 7a is a schematic flow chart of an embodiment of the present invention.

FIG. 7b is a schematic flow chart in more detail of a part of the flow chart of FIG. 7a.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

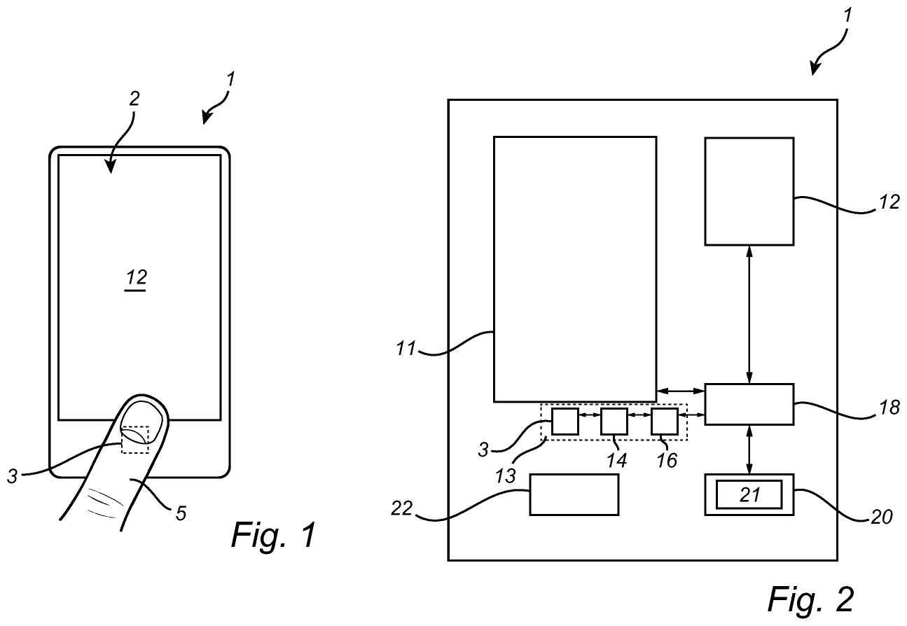

FIG. 1 shows an electronic device 1, here in the form of mobile phone, e.g. smartphone, comprising a display 12 of a display stack 2, e.g. comprising touch functionality (i.e. a touch display 12) and a fingerprint sensor 3. The fingerprint sensor 3 comprises fingerprint sensor circuitry, e.g. for outputting a grey-scale image or the like where different intensities in the image indicate the contact between a detection surface of the fingerprint sensor 3 and a finger 5 placed there on, e.g. as part of fingerprint authentication or navigation using the fingerprint sensor.

The fingerprint sensor 3 may operate according to any sensing technology. For instance, the finger print sensor may be a capacitive, optical or ultrasonic sensor. Herein, a capacitive fingerprint sensor, which may be preferred for some applications, is discussed as an example. The fingerprint sensor may comprise a two-dimensional array of fingerprint sensing elements, each corresponding to a pixel of the image outputted by the fingerprint sensor, the pixel e.g. being represented by a grey-scale value. The fingerprint sensor may be located at a side of the display stack 2, outside of the display area of the display 12, as shown in FIG. 1. The outputted image may for instance be in the form of a two-dimensional or one-dimensional pixel array, e.g. of grey-scale values. Each image pixel may provide an image intensity, be it of a grey-scale value or other value. For example, for a capacitive fingerprint sensor, a high pixel intensity (e.g. white in grey-scale) implies low capacitive coupling and thus a large sensed distance between the detection surface and the fingerprint topography. A high pixel intensity may result because the finger does not cover the part of the detection surface where the sensing element corresponding to the pixel is located. Conversely, a low pixel intensity (e.g. black in grey-scale) implies high capacitive coupling and thus a small sensed distance between the detection surface and the fingerprint topography. A high pixel intensity may result because the corresponding sensing element is located at a ridge of the fingerprint topography. An intermediate pixel intensity may indicate that the sensing element is covered by the finger topology but is located at a valley of the fingerprint topography.

Referring to the block diagram in FIG. 2, the electronic device 1 in FIG. 1 comprises the display stack 2 comprising a touch sensor 11 and the display 12. The electronic device also comprises a fingerprint sensing system 13 comprising the fingerprint sensor 3, fingerprint image acquisition circuitry 14 and image processing circuitry 16. Further, the electronic device 1 comprises a data storage 20, e.g. in the form of a memory, which may be shared between different components of the electronic device, such as the fingerprint sensing system 13. The data storage 20 holds software 21, in the form of computer-executable components corresponding to instructions, e.g. for the fingerprint sensing system 13. Thus, the data storage 20 may functionally at least partly be comprised in the fingerprint sensing system 13.

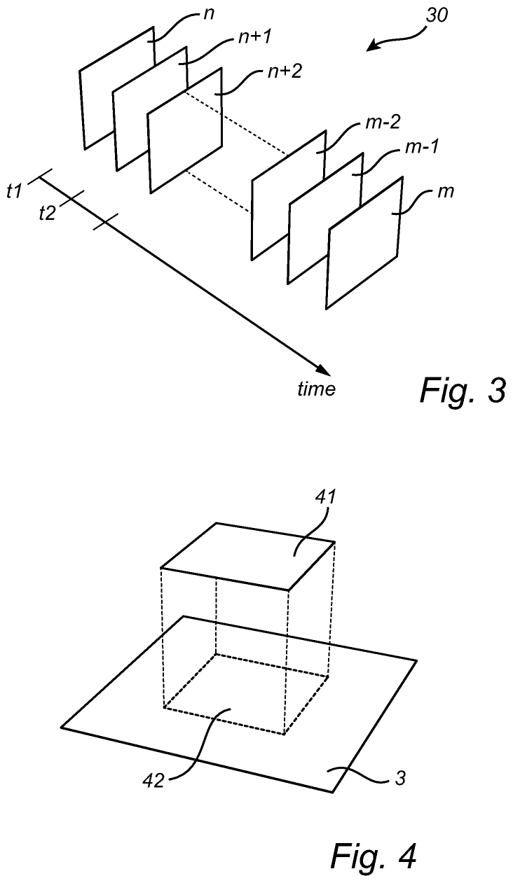

Accordingly (see also FIGS. 3-5), embodiments of the fingerprint sensing system 13 comprises a fingerprint sensor 3, processing circuitry 16, and data storage 20 storing instructions 21 executable by said processing circuitry whereby said fingerprint sensing system is operative to, on a surface of the fingerprint sensor, receive a finger 5 having a fingerprint topography. The fingerprint sensing system is also operative to, by means of the fingerprint sensor, acquire an image n of the fingerprint of the received finger. The fingerprint sensing system is also operative to divide an image area 41 of the acquired image, corresponding to a sensor area 42 of the fingerprint sensor, into a plurality of image regions r, said regions partly overlapping each other and covering the whole image area. The fingerprint sensing system is also operative to, based on image analysis of each of the plurality of image regions, determine that the finger covers the whole sensor area.

In some embodiments, the fingerprint sensor 3 is a capacitive, ultrasonic or optical fingerprint sensor, e.g. a capacitive fingerprint sensor.

In some embodiments, the fingerprint sensor 3 is covered by a glass layer, e.g. by means of a cover glass or a glass coating, e.g. protecting the sensing elements and providing the detection surface of the fingerprint sensor.

The data storage 20 may be regarded as a computer program product 20 comprising computer-executable components 21 for causing the fingerprint sensing system 13 to perform an embodiment of the method of the present disclosure when the computer-executable components are run on processing circuitry 16 comprised in the fingerprint sensing system. Additionally, any mobile or external data storage means, such as a disc, memory stick or server may be regarded as such a computer program product.

The electronic device also comprises a device control unit 18 configured to control the electronic device 1 and to interact with the fingerprint sensing system 13. The electronic device also comprises a battery 22 for providing electrical energy to the various components of the electronic device 1.

Although not shown in FIG. 2, the electronic device may comprise further components depending on application. For instance, the electronic device 1 may comprise circuitry for wireless communication, circuitry for voice communication, a keyboard etc.

The electronic device 1 may be any electrical device or user equipment (UE), mobile or stationary, e.g. enabled to communicate over a radio channel in a communication network, for instance but not limited to e.g. mobile phone, tablet computer, laptop computer or desktop computer.

The electronic device 1 may thus comprise an embodiment of the fingerprint sensing system 13 discussed herein, and a device control unit 18 configured to interact with the fingerprint sensing system.

In some embodiments, the device control unit 18 is configured to interact with the fingerprint sensing system 13 such that a navigation input of the finger 5 detected by the fingerprint sensing system is detected as a command for control of the electronic device 1 by the device control unit.

As a finger 5 contacts a detection surface of the fingerprint sensor 3, the fingerprint sensor is activated to by means of the fingerprint image acquisition circuitry 14 acquire an image n, or a time-sequence 30 of images n to m (herein also denoted n . . . m) as illustrated in FIG. 3. Such a time-sequence 30 may comprise at least a first image n, taken at a first time point t1, and a second image n+1, taken at a second time point t2 which is in time domain after the first time point t1. Embodiments of the present invention may be applied to any of the images n . . . m, e.g. n, n+1, n+2, m−2, m−1 or m as shown in FIG. 3. If one of the images n . . . m is analysed and it is determined that the finger 5 is not covering the whole sensor area, the method may be applied to another of the images n . . . m.

FIG. 4 illustrates how an image area 41 corresponds to a sensor area 42 of the detection surface of the fingerprint sensor 3. The image area 41 may be the whole or a part of the image n (or any of the images n . . . m), and may correspond to the whole or a part of the detection surface of the fingerprint detector 3. In the example of FIG. 4, the sensor area 42 is a sub-area of the detection surface, why the image area 41 comprises only pixels from a subgroup of the sensing elements of the fingerprint sensor, typically those sensing elements positioned right underneath the sensor area 42.

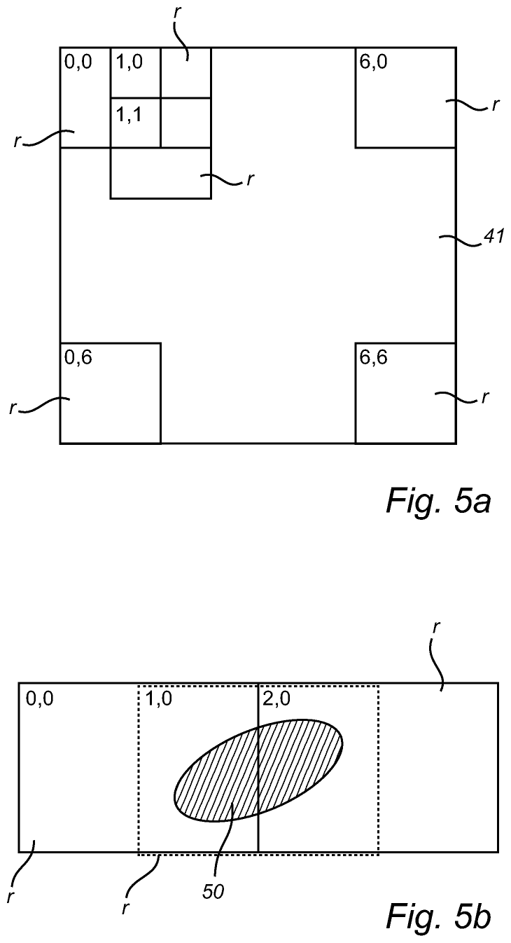

FIG. 5a shows an example of an image area 41 which has been schematically divided into a plurality of image regions r. To not clutter the figure, only a few of the image regions which the image area is divided into are shown. Coordinates of each image region r is given in the upper left corner of each image region. In the example of the figure, each image region is square, i.e. of 8×8 pixels, but any pixel ratio or number of pixels of each region r is possible. It may be convenient that all regions r are of the same size, but using different size regions may also be desirable in some embodiments. In the figure, the image area is divided into a total of 49 (7×7) image regions, with coordinates of 0 to 6 in each dimension, but any number of regions may be used, e.g. 25 (5×5) or 81 (9×9) or more regions. The regions r are overlapping. Each region r may overlap with neighbouring regions in both dimensions of a two-dimensional image area 41, e.g. by at least 20, 30, 40 or 50%. In the example of FIG. 5a, each image region r overlaps by 50% with each of its closest neighbour images, i.e. having integer coordinates in any one of the two dimensions which is higher or lower by one.

An advantage with overlapping regions r is illustrated by means of FIG. 5b, in which three of the regions r of FIG. 5a are shown. A high-intensity part 50 of the image area 41, corresponding to a non-covered part of the sensor area 42, is divided between the two non-overlapping regions r having the coordinates 0,0 and 2,0, respectively. Each of these two non-overlapping regions may only to a lesser degree comprise the high-intensity part 50, why an average intensity value of the region may not be affected by the high-intensity part to such a degree that detection of the high-intensity part, and thus the non-covered part, is triggered. However, by using a third region r, having the coordinates 1,0 in this example, which overlaps both of the 0,0 and 2,0 regions, here by 50% each, this third region may to a larger degree comprise the high-intensity part and be affected by the high-intensity part to such a degree that detection of the high-intensity part, and thus the non-covered part, is triggered.

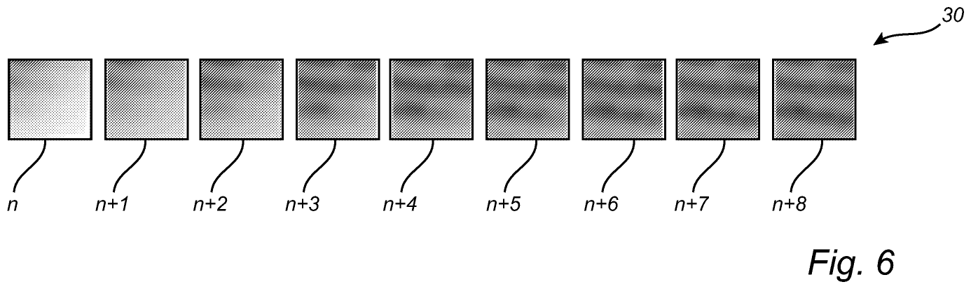

FIG. 6 shows a time-sequence 30 of grey-scale 32×32 pixel images n to n+8 from a capacitive fingerprint sensor 3 after activation. The sequence 30 of FIG. 6 illustrates how a finger 5 is only partly in contact with the detection surface in the first images while being in stable contact over the whole sensor area in the last images. The sequence of FIG. 6 appears to show a finger which makes contact with the sensor 3 from the upper left corner.

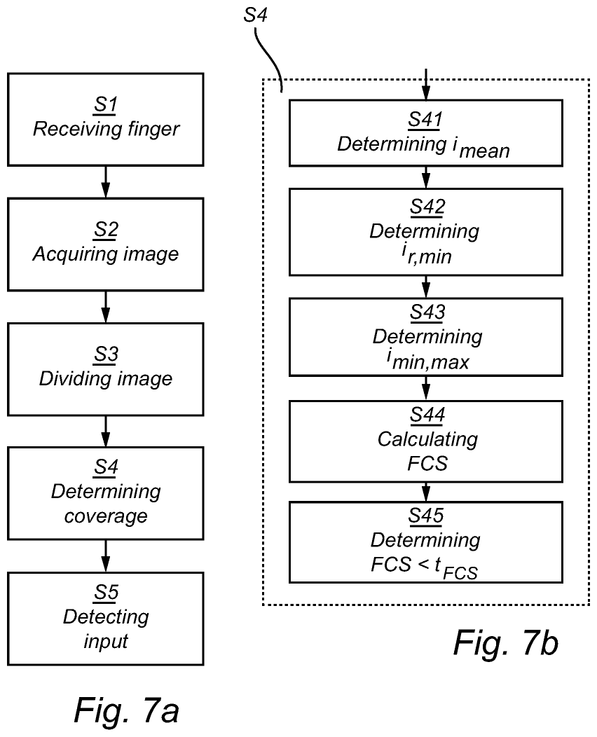

FIG. 7a is a flow chart of an embodiment of the method of the present invention. On a detection surface of the fingerprint sensor 3, a finger having a fingerprint topography is received S1. Then, by means of the fingerprint sensor 3, an image n of the fingerprint of the received finger is acquired S2. The image may be any image n . . . m of a time-sequence 30 of images. An image area 41 of the acquired image n is divided S3 into a plurality of image regions r. The image area 41 corresponds to a sensor area 42 of the fingerprint sensor. The regions are partly overlapping each other and jointly cover the whole image area. Based on image analysis of each of the plurality of image regions, it is then determined S4 that the finger covers the whole sensor area of the fingerprint sensor.

In some embodiments, after the determining S4 that the finger 5 covers the whole sensor area 42, a navigation input from the finger is detected S5. The navigation input may e.g. be based on gesture recognition, which may for instance facilitate navigation in e.g. a menu or the like of a GUI. The detecting S5 of the navigation input may comprise detecting a pressure of the finger 5 against the sensor area 42 or detecting a movement of the finger 5 relative to the sensor area 42. As mentioned above, navigation actions may e.g. include pressure detection indicative of a selection, push/click on a button or link or 30 the like, and movement detection indicative of steering a pointer or the like, e.g. of a GUI presented by the display stack 2. In other embodiments, an authentication operation may be triggered by the determining S4 that the finger 5 covers the whole sensor area 42.

In some embodiments, the determining S4 that the finger 5 covers the whole sensor area 42 comprises comparing an average intensity value iₘₑₐₙ of the image area 41 with at least one intensity value it of each of the image regions r. The average intensity value iₘₑₐₙ of the image area may e.g. be an average grey-scale value of all pixels in the image area, or of groups of pixels in the image area. The at least one intensity value it of each of the image regions r may e.g. be an average intensity value, a maximum intensity value or a minimum intensity value, e.g. of grey-scale values of all pixels in the image region, or of groups of pixels in the image region, preferably a minimum intensity value i_{r,min} of each image region.

FIG. 7b is a flow chart illustrating an example of how it can be determined S4 that the finger covers the whole sensor area by means of image analysis. An average intensity value iₘₑₐₙ of the whole image area 41 is determined S41, e.g. an average grey-scale value over all pixels in the image area. For each of the image regions r, a minimum intensity value i_{r,min} is determined S42, e.g. the lowest grey-scale value of all pixels in the region r. Then, a maximum value i_{min,max} from the determined minimum intensity values for all regions r is determined S43, e.g. the highest grey-scale value there is among the lowest grey-scale value of each region (if this value is high, that means that, in at least one of the regions, none of the pixels is dark). The FCS is calculated S44 as the ratio between said maximum value and said average intensity value,

$$i . e . FCS = \frac{{i}_{min , max}}{{i}_{mean}} .$$

Then it can be determined S45 that the finger covers the sensor area when the FCS is below a predetermined threshold t_{FCS}, i.e. FCS<t_{FCS}. The FCS may for example be within the range of 0.5-0.9 when the finger covers the whole sensor area, e.g. the fingerprint topography is in contact with the detection surface over the whole sensor area. Thus, the threshold t_{FCS} may conveniently be at least 0.9, e.g. within the range of 0.95-1.1

In some embodiments, the sensor area 42 covers the whole detection surface of the fingerprint sensor 3, i.e. the sensor area 42 is not a sub-area of the detections surface, whereby essentially all the sensing elements of the fingerprint sensor 3 are used to form pixels in the image area 41. In some other embodiments, the sensor area 42 covers only a part of the fingerprint sensor 3. It may e.g. be enough that the sensor area 42 covers only a part, such as 30, 50 or 70%, of the detection surface of the fingerprint sensor 3, e.g. depending on the size and/or resolution of the fingerprint sensor 3, in order to be enabled for an action, such as authentication and/or navigation as discussed herein.

In some embodiments, the determining S4 that the finger 5 covers the whole sensor area 42 comprises determining that the finger is in contact with the surface of the fingerprint sensor 3 over the whole sensor area. Although some sensor technologies, e.g. capacitive, may allow for fingerprint sensing also when the fingerprint topography hovers just above the detection surface, it may be convenient, e.g. for obtaining a stable image n, that the fingerprint topography, typically the ridges thereof, is in direct physical contact with the detection surface. The detection surface may be provided by e.g. a cover glass or glass coating of the fingerprint sensor 3, protecting the fingerprint sensing elements.

As also discussed with reference to FIG. 5a, in some embodiments of the present invention, an overlap between at least two, e.g. called a first region and a second region, of the plurality of image regions r is at least 20%, such as at least 30, 40 or 50%. Preferably, each of the plurality of regions r has an overlap with all its immediate neighbours in both dimensions.

The image regions r may have any shape or size, but in some embodiments each of the plurality of image regions r has size of at least 8×8 pixels of the acquired image n. In some embodiments, each of the plurality of image regions r corresponds to a sensor region, being a sub-area of the sensor area 42, having a size of at least 0.48 mm times 0.48 mm of the sensor area.

As previously mentioned, the acquired image n, e.g. any image n . . . m of an acquired time-sequence 30 of images, may be a grey-scale image.

The present disclosure has mainly been described above with reference to a few embodiments. However, as is readily appreciated by a person skilled in the art, other embodiments than the ones disclosed above are equally possible within the scope of the present disclosure, as defined by the appended claims.

What is claimed is:

1. A method of determining that a finger covers a sensor area of a fingerprint sensor, the method comprising:
on a detection surface of the fingerprint sensor, receiving a finger having a fingerprint topography;
by means of the fingerprint sensor, acquiring an image of the fingerprint of the received finger;
dividing an image area of the acquired image, corresponding to the sensor area of the fingerprint sensor, into a plurality of image regions, said regions partly overlapping each other and covering the whole image area; and
based on image analysis of each of the plurality of image regions, determining that the finger covers the whole sensor area.

2. The method of claim 1, wherein the determining that the finger covers the whole sensor area comprises comparing an average intensity value of the image area with at least one intensity value of each of the image regions.

3. The method of claim 1, wherein the determining that the finger covers the whole sensor area comprises:
determining an average intensity value of the image area;
for each of the image regions, determining a minimum intensity value;
determining a maximum value from the determined minimum intensity values for all regions;
calculating a finger contact score (FCS) as the ratio between said maximum value and said average intensity value; and
determining that the finger covers the sensor area when the FCS is below a predetermined threshold.

4. The method of claim 1, wherein the sensor area covers the whole detection surface of the fingerprint sensor.

5. The method of claim 1, wherein the sensor area covers only a part of the fingerprint sensor.

6. The method of claim 1, wherein an overlap between at least two of the plurality of image regions is at least 20%.

7. The method of claim 1, further comprising:
after the determining that the finger covers the whole sensor area, detecting a navigation input from the finger.

8. The method of claim 7, wherein the detecting of the navigation input comprises detecting a pressure of the finger against the sensor area.

9. The method of claim 7, wherein the detecting of the navigation input comprises detecting a movement of the finger relative to the sensor area.

10. The method of claim 1, wherein the determining that the finger covers the whole sensor area comprises determining that the finger is in contact with the surface of the fingerprint sensor over the whole sensor area.

11. The method of claim 1, wherein each of the plurality of image regions has size of at least 8×8 pixels of the acquired image.

12. The method of claim 1, wherein each of the plurality of image regions corresponds to a sensor region having a size of at least 0.48 times 0.48 mm of the sensor area.

13. The method of claim 1, wherein the plurality of image regions consists of at least 25 image regions.

14. The method of claim 1, wherein the acquired image is a gray-scale image.

15. A non-transitory computer-readable medium storing a computer program product comprising computer-executable components for causing a fingerprint sensing system to perform the method of claim 1 when the computer-executable components are run on processing circuitry comprised in the fingerprint sensing system.

16. A fingerprint sensing system comprising:
a fingerprint sensor;
processing circuitry; and
data storage storing instructions executable by said processing circuitry whereby said fingerprint sensing system is operative to:
on a surface of the fingerprint sensor, receive a finger having a fingerprint topography;
by means of the fingerprint sensor, acquire an image of the fingerprint of the received finger;
divide an image area of the acquired image, corresponding to a sensor area of the fingerprint sensor, into a plurality of image regions, said regions partly overlapping each other and covering the whole image area;
based on image analysis of each of the plurality of image regions, determine that the finger covers the whole sensor area.

17. The fingerprint sensing system of claim 16, wherein the fingerprint sensor is a capacitive, ultrasonic or optical fingerprint sensor.

18. The fingerprint sensing system of claim 16, wherein the fingerprint sensor is covered by a glass layer.

19. An electronic device comprising:
the fingerprint sensing system of claim 16; and
a device control unit configured to interact with the fingerprint sensing system.

20. The electronic device of claim 19, wherein the device control unit is configured to interact with the fingerprint sensing system such that a navigation input of the finger detected by the fingerprint sensing system is detected as a command for control of the electronic device by the device control unit.
